(19) United States
(12) Patent Application Publication
(10) Pub. No.: US 2004/0254963 A1
(43) Pub. Date: Dec. 16, 2004

(54) Method for providing data mapping for facility asset information

(76) Inventors: Mark L. Bradley, Benton County, OR (US); Anthony Baker, Benton County, OR (US)

Correspondence Address: JAMES F HARVEY III, HARVEY & ASSOCIATES, 3750 WEST MAIN STREET, SUITE 108, NORMAN, OK, 73072-4657, US

(21) Appl. No.: 10/458,024

(22) Filed: Jun. 10, 2003

(51) Int. Cl. G06F 17/30

(52) U.S. Cl. 707/202

(57) ABSTRACT

The present invention provides a business method for building a database of displays containing facility information pertinent to the needs of emergency services personnel and interactively viewing the database. The invention provides a business entity with contractually specified interfaces with a facility provider entity, an asset provider entity, and a user entity. A facility mapping function uses facility information provided by the facility provider to produce layouts that graphically represent the physical configuration of the facility. An asset categorization function uses asset information provided by the asset provider or the facility provider to produce a schema consisting of generic categories to which assets can be assigned. An asset assignment function is provided to assign an assets to categories and a display building function is provided to graphically assign facility information and asset information to displays for presentation to the user entity through a display presentation function.

### BACKGROUND OF THE INVENTION

The present invention relates to a business method providing the location and characteristics of a facility and its assets to emergency and facility management personnel, and more particularly to systems for interactive display of such information using data mapping techniques. This invention is directly applicable to Homeland Security.

Modern society experiences numerous emergency situations which disrupt the harmony of daily living. Some of these situations may be termed natural disasters in which forces of nature may damage life and property. Such natural disasters may be tornados, hurricanes, earthquakes, volcanic eruptions, outbreaks of disease, collapse of structures, and the like. Other situations may be termed man-made disasters in which persons or groups of persons may deliberately seek to inflict damage and loss of life. Such man-made disasters may include such situations as hostage taking, robberies, terroristic acts, arson, burglary, thefts, wanton killing and mayhem, and the like.

These emergency situations, both man-made and natural, generally involve responses on the part of governmental agencies responsible for maintaining peace and tranquility, such as the police agencies, fire departments, and the 911 dispatch centers. Other non-governmental organizations may also be called upon as needed, for example, ambulance services, electrical line crews, and heavy equipment operators. Military organizations may also be called into service to maintain the peace when other agencies are overwhelmed. All these organizations may be collectively termed “emergency services”.

These emergency situations generally involve responses on the part of governmental agencies responsible for maintaining peace and tranquility, such as the police and the fire department. Other non-governmental organizations may also be called upon as needed, for example, ambulance services, electrical line crews, medical teams, and heavy equipment operators. Military organizations may also be called into service to maintain the peace when other agencies are overwhelmed. All these organizations may be collectively termed “emergency services”.

When man-made structures are involved, these emergency services may need detailed information concerning the man-made structure in order to efficiently and adequately respond in the application of resources to whatever emergency situation occurs. Such man-made structures may be schools, water plants, sewer plants, banks, private homes, security buildings, technical businesses, government buildings, airports, sea ports, factories, mills, mines and so forth. For example and more specifically, when responding to a hostage situation in a school, the police may find it useful to have access to the layout of the building and ascertain the locations of telephones, telephone numbers, attic entrances, crawl spaces, steam or services tunnels, mechanical areas, configuration of door locking mechanisms and emergency equipment. When the locations of the hostages and hostage takers are discovered, the configuration of the building and how entrances and exits relate to these locations will be known to the emergency services. Knowing how the building relates to the circumstances via the layout and photographs of each room in the facility can greatly help enhance the responses of the Emergency Response Services (ERS) system and assist in producing a favorable outcome. Without this detailed and easily accessed information, SWAT and emergency services are relegated to relying on the hurried sketches of a distraught janitor, administrator, parent, student, or worker from the facility. This information is regarded as marginally reliable by ERS personnel because of the circumstances under which it was obtained. It is well known that placing full reliance on such a sketch is foolhardy because people tend to forget, remember incorrectly, and construe and misplace details when they are under the stress of a tumultuous circumstance. Having detailed and accurate information regarding a facility is considered information that one can use to direct resources in a timely manner generating actionable intelligence for resolving the incident.

Each emergency service generally has a different set of requirements for such knowledge or information, but as is often the case, the emergency services responding to the situation may require the same or similar information. These emergency services are unlikely to have their own database containing the information pertaining to the man-made structure, or they may totally lack such information and may require assistance from other persons at the time the situation occurs, such as the maintenance personnel or the facility manager, provided that they can be found or aren't an integral part of the incident. When several such emergency services are involved in a situation, then the information used by each emergency service may conflict due to errors in their respective data bases or the timeliness of their last data update. Furthermore, the data required by the emergency service may be difficult to obtain, even when it is available to the emergency service, and this difficulty in obtaining the data results in delays.

As can be seen, there is a need for a common database that may be accessed by all the emergency services responding to a situation involving a man-made structure; the database should be capable of being rapidly accessed and it should contain current data relevant to the situation. Additionally, the database should be available only to the emergency services, facility managers, maintenance personnel and not to the general public.

### SUMMARY OF THE INVENTION

In one aspect of the invention, a business system for presentation of information to a user entity is provided, where the system comprises a business entity having a first contractually specified interface with a facility provider entity in which the business entity acquires facility information from the facility provider entity describing the physical characteristics of a facility. The business entity performs a facility mapping function using the facility information to produce one or more layouts having coordinate systems that graphically represent the physical configuration of the facility. The business entity also has a second contractually specified interface between the business entity and an asset provider entity, in which the business entity acquires asset information for assets located within the facility. The business entity performs an asset categorization function on the asset information to produce one or more generic categories to which the asset can be assigned, an asset assignment function to assign an asset to a category, and a display building function to graphically assign facility information to one or more layout displays and asset information to a plurality of category displays. Finally, the business entity has a third contractually specified interface between the business entity and a user entity, in which the business entity selectively displays the facility information and categories of asset information to a user entity by performing a display presentation function allowing the user entity to selectively choose a layout and to choose one or more categories to be superimposed upon the selected layout. The display presentation function depicts the relationship between the assets and the physical characteristics of the facility on the common coordinate system.

In another aspect of the invention, a method is provided in which a man-made facility is defined in terms of one or more floor plans comprising a facility site plan. The assets having relevance to emergency situations are identified and categorized according to the taxonomy of a pre-defined emergency asset schema. The assets are then associated with one or more such categories and a location on a selected floor plan, or facility site plan that is a part of the facility description. The user is given the capability to select a facility, a particular floor plan or facility site plan associated with the selected facility, and one or more categories of assets for superimposition over the selected floor plan, all of which is presented to the user for viewing on an interactive screen or terminal.

In another aspect of the invention, a set of encrypted passwords is associated with each emergency service or user entity to allow the particular emergency service provider, according to their jurisdictional responsibility, access to the database containing facility information.

In another aspect of the invention, a software product is described which may be accessed by means of a world wide communications system.

These and other features, aspects and advantages of the present invention will become better understood with reference to the following drawings, description and claims. For a better understanding of the invention, its operating advantages and the specific objects attained by its uses, reference should be made to the accompanying drawings and descriptive matter in which there are illustrated preferred embodiments of the invention. The foregoing has outlined some of the more pertinent aspects of the invention. These aspects should be construed to be merely illustrative of some of the more prominent feature and applications of the present invention. Many other beneficial results can be attained by applying the disclosed invention in a different manner or by modifying the invention within the scope of the disclosure.

### BRIEF DESCRIPTION OF THE DRAWINGS

FIG. 1 is a description of the general organization of the database in terms of facilities, layouts, assets, and categories.

FIG. 2 is a flow chart of the phases comprising the process of developing a database describing the facility and its layouts, assets, and categories.

FIG. 3 is a schematic showing the entities comprising the business method and the functions included within the business method entity.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims.

The invention provides an advantageous method of providing emergency service personnel, i.e. user entities, with access to facility information and the location of assets associated with the facility, so that they can efficiently preplan their activities with relationship to an emergency situation that may involve the facility. For purposes of this invention, a facility may be defined as a man-made site, such as a school, water plant, sewer plant, bank, private home, assembly building, manufacturing plant, technical business, government building, airport, sea port, factories, mills, mines, or similar location, where an emergency situation is likely to occur.

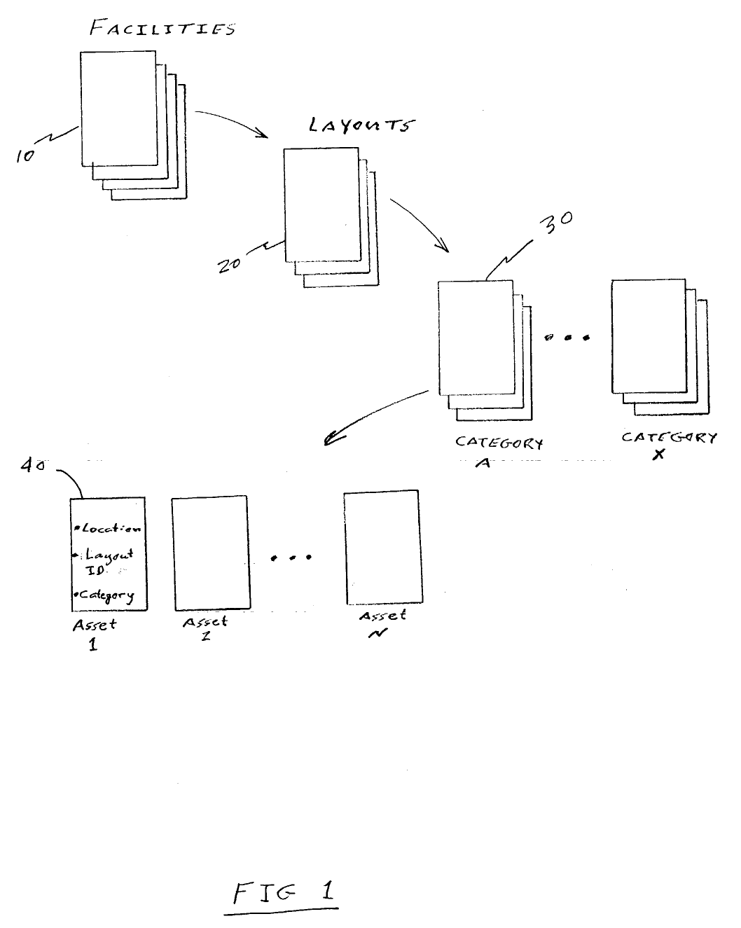

Referring to FIG. 1, the facility 10 may be conceptually thought of as a set of plans or layouts 20 that graphically depict the two-dimensional positioning and relationship between the elements that make up the facility 10. For example, a multi-story building may have a floor plan or layout for each story of the building and the basement. An oil refinery may have a layout of the area in which the refining equipment is located, where the refining equipment may comprise cracking towers, catwalks, gas burn off pipes, storage tanks, and so forth; the total layout may comprise a series of sectional layouts as is convenient. These layouts 20 are visually defined by standard symbology well known to the art. There may be several instances of a layout 20 for the same physical facility 10. For example, one layout may consist of a floor plan showing the walls and doors for the school. A second layout may consist of the duct work with relationship to the walls and doors. A third layout may consist of the structural members supporting the roof, and so on.

Assets 40 may be located within the facility 10. An asset is an item of interest, such as, for example, a fire extinguisher, electrical panel, security panel, or an emergency defibrillator. They are items which may be useful in dealing with an emergency situation, and the identification of such items is highly dependent upon the type of emergency situation. Those items having common characteristics may be grouped in categories 30 for display as a group. Some characteristics are common to all assets 40, such as the location of the asset with respect to a particular layout. Choice of the nature of the categories 30 may be made according to empirical criteria and may be systematized into an emergency asset schema which may be expanded as time and experience dictate.

The data comprising each facility 10 may be stored in a central database for common and simultaneous access by emergency personnel. Through communications facilities such as a global communications network, an access mechanism, such as a browser, allows an emergency person to select a facility 10 and a layout 20 for presentation on an interactive terminal, according to the emergency person's jurisdiction. A menu containing the categories 30 of assets 40 associated with the selected layout 20 of the selected facility 10, and the emergency person may choose one or more categories 30 for simultaneous superimposition upon the selected layout 20. In this manner, the emergency personnel may be supplied with knowledge of the existence of assets in the area of interest and the relationship of the asset to the layout, or floor plan of the facility.

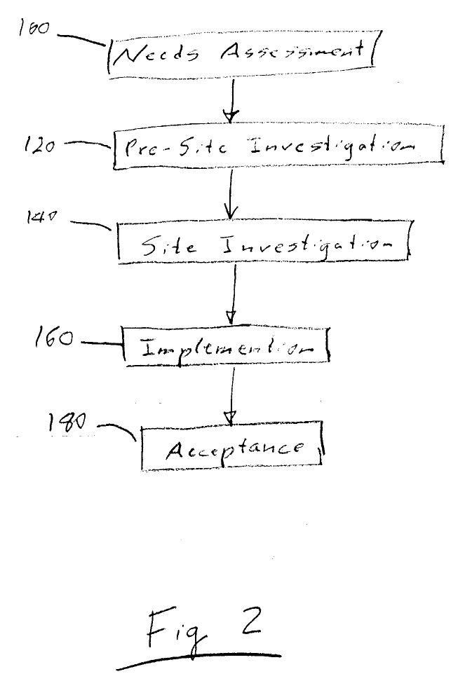

Referring now to FIG. 2, a method for developing the required data for use by user entities (emergency personnel) will now be described in more detail. The first step of the method comprises a Needs Assessment Phase 100. A meeting may be held with the entity desiring to develop and implement a facility mapping capability. The specific goal for the project will be identified. For example, there may be a need to provide information suitable for fire fighters, a hostage situation, or an expected natural disaster (hurricane, tornado, or earthquake.) The scope of the facility will be identified and documented so that suitable maps and drawings may be developed. When agreement on the general scope of the project is made, then a contract will be drawn up and a fee will be established. A site investigation will then be scheduled to further identify the items of interest to be categorized and included as overlays to the maps and drawings. Other entities may desire to add information pertinent to their particular activities to the Needs Assessment Phase 100. These additional entities may be invited to attend the meeting or separate meetings may be held with these entities, either before the facility has been mapped or subsequently.

The next step of the process comprises a Pre-Site Investigation Phase 120. During this phase, more detailed information is developed. Site diagrams may be made, based upon the scope of the facility, to provide for such activities as developing a photographic record of various views of the facility, cataloging pertinent assets, and identifying exterior assets. If appropriate, an aerial photograph of the facility may be made and converted into digital format; otherwise, a digital description of the facility is made from existing diagrams. A master site diagram is developed for dividing the site into smaller interactive sites. This master site diagram may be digitized and placed in format appropriate for developing overlays containing site and facility assets.

The next step of the process comprises a Site Investigation Phase 140. During this phase, the scheduled site investigation may be implemented. The technical personnel tasked to develop the facility description will visit the site and gather more detailed information for digital input to the master database representing the facility or site. First, the personnel may obtain photographs of the facility and correlate the photographs to locations on the facility diagram. Items may be identified and numbered. Such items may include, but not be limited to, interior rooms; walls; exterior walls; aspects of assets of the facility or site; crawl space entrances and subsequent photos of interior of crawl spaces; attic entrances and subsequent photos of interior of attics as necessary; and subterranean entrances (e.g. steam tunnels) and photographs of the subterranean spaces with a notation if passable by child and or adult. A review will be made of the photographic record to ensure that they accurately describe the site or facility.

Second, categorized items will be digitally photographed and cataloged. Such items may include, but not be limited to, such items as electronic surveillance devices; fire extinguishers; exterior fire hydrants (with main size, relative pressure, and a measure of the distance to facility or point of reference); fuel and chemical storage (with an indication of the type of chemical for purposes of applying HAZMAT symbols); telephones (with an indication of telephone numbers and extensions); computers (records of email addresses if requested by client); emergency off-site assembly locations for personnel; fire exits; key boxes; roof accesses; gas/fuel shut off valves; gas/fuel meters; water shut off area; first aid kits or stations; defibrilators; intruder alarm panels and the zone map associated with each panel; fire alarm panel, along with the code and procedure for using the code to deactivate the alarm; fire sprinkler or halon shut off valves and the zones they cover; stand pipe(s) sprinkler hook-ups for fire department so that they can be charged with water and the zones they cover; fire supply shacks; electrical panels; telephone panels; exterior electrical shut offs or breakers (usually main line to facility); and stairs and elevators. Additional items might be as follows:

1. Elevator control panels and equipment rooms

2. Mechanical rooms

3. Facility characteristics (facility construction materials and framing including roof and foundation composition

4. Optical line locations

5. Steam line locations

6. Conveyor systems

7. Chemical pipe routes

8. Other infrastructure systems

9. HVAC systems and computer controls for said systems

10. Subterranean systems

11. Underwater systems

12. Emergency helicopter landing zones

13. Weapons locations

14. Armory locations

15. Storage locations

16. Designated parking areas

17. Ground watering systems

Third, more detailed information is obtained. Measurements may be made of wall dimensions and correlated with the site or facility diagram for better representation of the premises. Emergency contact names and telephone numbers for facility may be recorded. Facility and emergency preparedness manuals may be obtained in electronic media form, if available. A review may be made of such recorded information to ensure its accuracy.

The next step of the process comprises the Implementation Phase 160. During this phase, the data gathered from prior phases may be reformatted and incorporated into a digital database. All photographs may be resized, formatted, cataloged for interactive use, and associated or linked with the basic facility diagram. Facility diagrams may be expressed in appropriate programming languages (such as Hypertext Markup Language (HTML)). Using the categorized items obtained in the prior step, a layering system may be implemented for multi level facilities using different colors. Appropriate symbols may be associated with the item locations for interactive placement on the diagrams. All other information obtained from the Site Investigation phase may be linked to the facility diagram and a custom menu bar may be created so that points of interest or assets to the facility can be chosen to overlay the facility diagram. Facility and emergency manuals may be formatted and linked to the custom menu bar for interactive reference. Finally, these data may be formatted as web pages and organized on a server for interactive access by multiple entities. Each of the entities may be given a user name and password. A final test and review may be performed to ensure that all data was correctly entered and implemented.

The final step of the process may comprise the Acceptance Phase 180. During this phase, the entity requesting the development tasking may be notified for purposes of meeting and reviewing the developed capability. Once approval is obtained, the web site may be activated for use in the field and by the ERS system. User names and passwords may be distributed to facility management and/or owners and to emergency services as directed by the facility management and/or owners. Emergency personnel may be trained as necessary in the use of the capability.

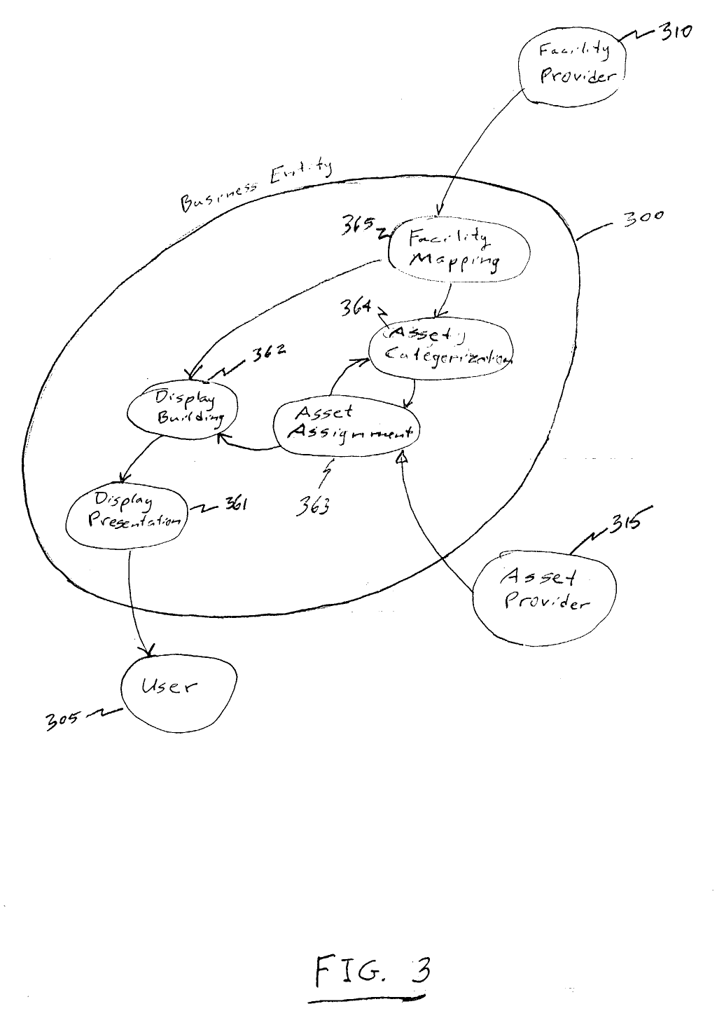

Referring now to FIG. 3, the invention may thus be generally described as a business entity 300 for supporting emergency services personnel, generally described as a user entity 305. This support is provided by a display presentation function 361 that allows the user entity 305 to select a layout display from a set of one or more layout displays, each having a graphical coordinate system, and then selecting one or more asset displays to be overlaid on the selected layout display according to the same coordinate system. The layout displays may consist of one or more graphical presentations showing a physical map or layout representing a facility such as, for example, a school, a church, a football stadium, or a chemical plant. The physical map may depict architectural floor plans, parking areas, streets, and other more or less permanent aspects of the facility that provide a context for locating emergency-related assets. A coordinate system may be associated with each layout, and several layouts may have the same coordinate system. For example, one layout may show the floor plan of a building and a second layout may show the electrical system for the building; both layouts would have the same coordinate system so that one could be seen in relationship with the other.

A facility mapping function 365 is provided by the business entity in which the business entity interacts with a facility provider entity 310 through a contractually specified interface. The “contract” between the business entity 300 and the facility provider entity 310 is simply the method by which the business entity 300 systematically obtains information from the facility provider entity through the Needs Assessment 100, Pre-Site Investigation 120, and the Site Investigation Phases 140, described previously.

All assets of interest to a user entity 305 may be identified and categorized according to a schema developed for the facility; this action may be termed the asset categorization function 364. This schema may be an empirical set of categories against which the assets are assigned, and it may be dynamically extended as each new set of assets is presented to the entity for categorization and incorporation into the schema. The categories may vary from facility to facility and each emergency asset, such as a first aid kit, may be assigned to one or more categories. A set of assets may be presented to the business entity 300 for categorization according to the schema and assigned to a category by means of the asset assignment function 363. The asset assignment function 363 assigns each asset to one or more categories and identifies the layouts upon which the asset may appear. The assignment of assets to categories may result in an interactive modification of the category schema, as new insights are gained from each new set of assets.

Information regarding the assets and the categories may be obtained by the business entity 300 through a second contractually specified interface between the business entity 300 and an asset provider entity 315. Here, the asset provider entity 315 may be the same organization as the facility provider entity 310 or it may be a completely different organization. For example, a plant manager may request that the business entity 300 set up a description of the plant and, concurrent with the initial building of the layouts, identify all points of ingress and egress to the plant as assets. The plant manager would in this case serve as both the facility provider entity 310 and the asset provider entity 315. Later, a fire department might find it useful to add a set of assets dealing with the locations of all fire alarm switches and fill the role as another asset provider entity 315.

A display building function 362 receives data from the facility mapping function 365 consisting of the layouts for a facility, from asset categorization function 364 the categories associated with the facility, and from the asset assignment function 363 the assets associated with the particular categories and the particular layouts; it develops a series of graphical category displays for simultaneous presentation of the assets in a category with the associated layout display in the form of an overlay. The display presentation function 361 may be provided to allow the user entity 305 to select a layout display for viewing by the user entity 305 along with one or more categories of assets associated with the selected layout display. The business entity 300 interfaces with the user entity 305 through a third contractually specified interface which provides the user 305 entity a procedure for selecting a layout from a set of one or more layouts, selecting one or more category displays from a set of category displays that are related to the selected layout, and presenting the selected layout and category displays on a common coordinate system so that their relationship may be ascertained.

The facility provider entity 315 provides facility information to the business entity 300 and the asset provider entity 315 similarly provides asset information. Generally speaking, the facility provider entity 310 may be the facility manager or some organization associated with the facility, such as the engineering department, that has detailed knowledge of the physical arrangement of the facility. The asset provider entity 315 may generally be an emergency services organization, such as an ambulance service or an electric utility, that provides information related to assets in which they have an interest. Note, however, that the facility provider entity 310 may also function as an asset provider entity 315, since the facility provider may wish to have its assets known to emergency services personnel in order to enable them to respond more rapidly to pertinent emergencies. The user entity 305 requests displays and reacts to the contents provided by the business entity 300. Note, however, that the user entity 305 and the asset provider entity 315 may be the same organization, such as, for example, a fire department.

As has been demonstrated, the present invention provides advantageous techniques for accessing and viewing facility information pertinent to an emergency situation. While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

We claim:

1. A business system for presentation of information to a user entity, the system comprising:
a business entity having a first contractually specified interface with a facility provider entity, wherein the business entity acquires facility information from the facility provider entity describing the physical characteristics of a facility;
the business entity performing a facility mapping function using the facility information to produce one or more layouts that graphically represent the physical configuration of the facility, each layout having a coordinate system;
the business entity having a second contractually specified interface with an asset provider entity, wherein the business entity acquires asset information for assets located within the facility;
the business entity performing an asset categorization function to produce one or more generic categories to which each asset can be assigned;
the business entity performing an asset assignment function to assign an asset to a category;
the business entity performing a display building function to graphically assign facility information to one or more layout displays and asset information to a plurality of category displays, each layout display having a common coordinate system;
the business entity having a third contractually specified interface with a user entity, wherein the business entity selectively displays facility information and categories of asset information to the user entity;
the business entity performing a display presentation function allowing the user entity to selectively choose a layout and to choose one or more categories to be superimposed upon the selected layout, wherein the relationship between the assets and the physical characteristics of the facility are shown on the common coordinate system.

2. The business system described in claim 1, wherein the facility provider entity and the asset provider entity are the same entity.

3. The business system described in claim 1, wherein the user entity and the asset provider entity are the same entity.

4. The business system described in claim 1, wherein the user entity is an emergency services provider.

5. The business system described in claim 1, wherein the asset provider entity is an emergency services provider.

6. A method of providing facility configuration information for presentation to a user, the method comprising
identifying a facility;
identifying one or more layouts associated with the facility;
identifying a set of categories comprising an emergency asset schema;
identifying assets within the facility;
associating each asset with a selected layout, the asset having a location associated with the layout;
assigning each asset within the facility to one or more categories;
providing a base display page showing the selected layout;
providing an overlay display page for each category for the selected layout, the overlay page comprising all assets assigned to the category that have locations associated with the selected layout; and,
providing the user with the capability of simultaneously displaying one or more overlay display pages superimposed over a selected layout.

7. The method described in claim 6, further comprising the step of providing the user the capability of selecting a facility.

8. The method described in claim 6, further comprising the step of accepting a password from the user that will allow the selected facility to be displayed.

9. The method described in claim 6, further comprising the step of providing the user with the capability of selecting one or more categories for superimposition upon the selected layout.
